(19) United States
(12) Patent Application Publication
(10) Pub. No.: US 2009/0007734 A1
(43) Pub. Date: Jan. 8, 2009

(54) FUEL INJECTOR CONNECTOR INSTALLATION TOOL

(75) Inventors: Alan P. Lulewicz, (US); Phillip K. Camarda, (US); Kenneth A. Zalucki, (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: DETROIT DIESEL, Detriot, MI (US)

(21) Appl. No.: 11/773,461

(22) Filed: Jul. 5, 2007

(51) Int. Cl. B25B 7/02

(52) U.S. Cl. 81/415

(57) ABSTRACT

A fuel injector connector installation tool is disclosed.

### BACKGROUND OF THE INVENTION

1. Field of the Invention

The present invention relates to an installation tool for attaching a fuel injector connector to a fuel injector.

The present invention further relates to a tool to install fuel injector connectors in heavy duty diesel engine application with a minimum of effort to substantially reduce worker fatigue due to performance of repetitive task of connecting fuel injector connector to a fuel injector.

2. Description of the Related Art

Williston, U.S. Pat. No. 6,935,436 discloses a double headed tent stake driver and puller having twin release levers for inserting and removing tent stakes, nails and the like. The driver and puller include a side hammer and coupler mounted on the distal end of a side hammer shaft. The coupler has an elongate body with an open end and a hallow core oversized to receive the head of the stake or nail. The coupler includes a pair of retractable keepers slidably received within a corresponding pair of slots. The keepers retain the stake once it is inserted into the coupler and present a surface from parting the extraction force upon the stake to be pulled from the ground. A pair of spring loaded release levers are provided to enable a one handed retraction of the keepers for receipt of the tent stake. When released, the spring loaded levers return the keepers to a closed position retaining the stake therein.

Ruggiero, U.S. Pat. No. 5,207,730 discloses a pair of pivotally joined jaws with a clamp coupled thereto for setting the jaws in a selected angular position and for preventing a pivotal widening of the jaws after an angle has been set. In addition, one of the jaws has an anvil extending therefrom and the side hammer assembly coupled to the handle that causes a percussive jarring of the jaws in order to free up an expansion tube from and evaporator line. Recesses formed adjacent terminal ends of the jaws engage gears on the expansion tube to enhance the grip of the tool on the expansion tube.

Rix, U.S. Pat. No. 5,020,203 is directed to a high pressure fuel injector installation removal tool for use in internal combustion engines that can be used to precisely locate and fuel injector during installation. The installation tool provides an alignment guide as well as mechanical impulse necessary to fully seat the injector in a base cavity. The alignment guide forms a location skirt with projected ears around the perimeter of the fuel injector during the installation procedure and thus provides a means to assure sufficient clearance between the fuel injector and surrounding components without the need for visual alignment.

Gadberry, U.S. Pat. No. 3,739,452 discloses a pair of elongated pivotally mounted jaws which extend from a mounting housing where in a camming member is vertically adjustable so as to engage the jaws above the point of pivotal mounting and effect a corresponding inward swinging of the lower gripping ends. The camming member is adjusted by an elongated adjusting bolt passing through a retaining bar fixed to the lower part of the housing and extending upwardly in threaded engagement with the camming member. A hammer mounting pulling shaft can be coupled to the upper end of the adjusting bolt.

### SUMMARY OF THE INVENTION

The invention is a hand pliers type tool constructed from hardened steel. The handle is rubber coated and with a standard design for ergonomic grip and is spring loaded for ease of use. The finger ends are designed to grip an injector header connector and engine harness connector mating the connections together. The finger ends control the travel distance by way of a set screw and lock nut. The invention addresses issues of operator fatigue on an assembly line. The connector mating action requires several pounds of effort. This invention eliminates fatigue by providing a way of mating the connectors with a much reduced effort.

The tool is a fuel injector connector installation tool, comprising a first portion having a length with opposing first and second ends; said first end terminating in a handle portion, said second end equipped with a first clamp; a second portion having a length with opposing first and second ends; said first end terminating in a handle portion and said second end equipped with a second clamp; said first and second portions pivotally connected to each other and resiliently biased away from each other such that forcing said handle portions toward each other causes the first and second clamps to move toward each other to apply compressive force to a connector and a fuel injector to connect them tighter; and releasing the compressive force applied to the handles permits the resiliently biasing of the first and second portions away from each other about the pivot attachment.

### BRIEF DESCRIPTION OF THE DRAWINGS

FIG. 1 is a top view of the fuel injector connector installation tool.

FIG. 2 is a detailed view of the clamps used with the fuel injector connector tool.

FIG. 3 is a detailed view of the fuel injector connector tool of the present invention installing a connector to a fuel injector in a heavy duty diesel engine.

### DETAILED DESCRIPTION OF THE PREFERRED EMBODIMENT(S)

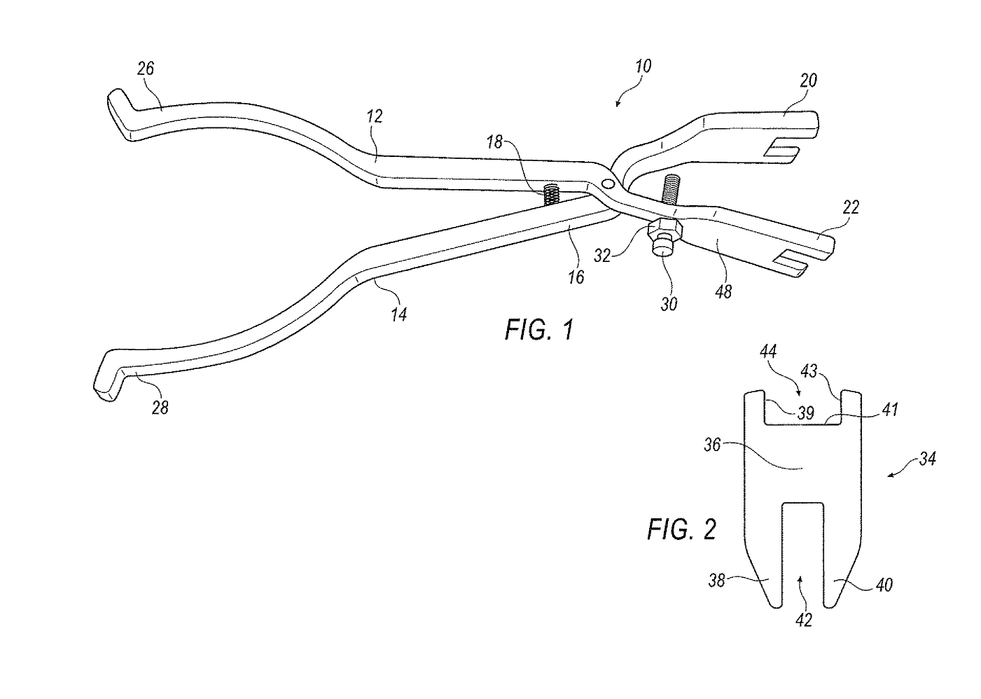

Turning now to the drawings wherein in like numerals refer to like structures, and particularly to FIG. 1, the tool 10 is comprised of a spring side portion 12 and a plug side portion 14 pivotally connected at 16 and urged away from each other by biasing spring 18. Each of the spring side and the plug side are equipped with clamps 20 and 22 that engage the injector and the wire connector and draw the two together by an operator pushing the handle ends 26 and 28 together to cause the clamps to close. An adjusting screw 30 and nut 32 is provided that can be used to adjust the amount the camps will be biased toward each other without over stressing either the connector or the injector. After the operation is completed, the operator releases tension on the handles and the biasing releases the clamps from the injector and connector.

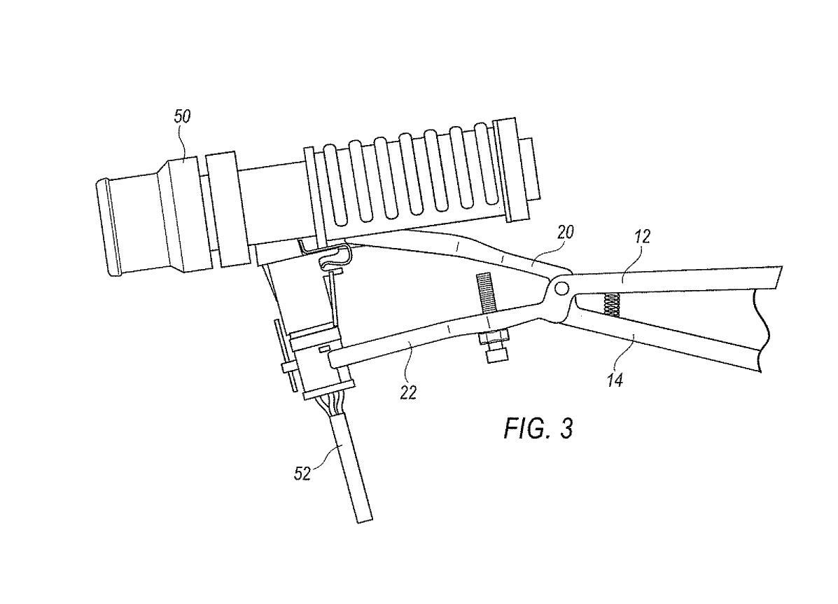

Turning now to FIG. 2, there is shown a detailed view of the clamps used in combination with the tool of FIG. 1. Specifically, clamp 34 is comprised of a body 36 having opposed separate flanges 38, 40, respectively to define a space 42 therebetweeen that is adapted to matingly receive the injector connector or the injector itself. Opposite the flanges is a receiving aperture 44 having floor 41 and sidewalls 39 and 43 adapted to matingly receive the terminal portion 48 of the first and second portions of the fuel injector connector installation tool. Specifically, the clamps are removably installed on the ends of the first and second portions of the fuel injector installation tool t engage the injector and the connectors and cause them to be joined when the handles of the tool are depressed together, thereby causing a clamping force to be exerted between the injector and the connector, thereby joining the two components. The tool can then be easily disengaged from the connector and the fuel injector by removing the injector and the connector from the space 42 by moving the tool away from engagement with the injector and connector assembly.

It is to be understood that the clamps may be inclined or bent to any angle to facilitate engagement between the tool, the claims and the connector and fuel injector. The angle of inclination for the clamp portions is dependent upon design of the injector, and connector, among other factors.

FIG. 3 is a detailed view of the fuel injector connector installation tool of the present invention installing a connector to a fuel injector in a heavy duty diesel engine. While a heavy duty diesel engine and injector are shown, it will be obvious that the tool has application for any fuel injector connector installation operation in any type of engine.

Specifically, a first portion, called the spring portion, is oriented so that the clamp it carries engages the injector 50. The opposing second portion, sometimes called the side portion is oriented so that the clamp it carried engages the fuel injector connector 52 from the wiring harness. Ordinarily, it takes about 6 pounds of pressure to engage the connector to the fuel injector and this operation results in worker fatigue from the repetitive nature of the task. The tool is then used by a worker who forces the handle portions together, thereby generating a clamping force to force the connector into mating engagement with the injector. Note that the adjuster screw assembly is oriented to prevent the travel of the first and second portions relative to each other about the pivot, thereby limiting the clamping force being applied to the connector and the fuel injector. When the connector is installed to the injector, the handles are released, and the resilient bias, shown as a spring, biases the first and second portions apart. The clamps are preferably inclined relative to each other to facilitate engagement with the injector and connector. The angle of inclination is a matter of design choice, depending upon the injector and connecter to be serviced by the tool of the present invention.

The words used in describing the invention are words of description and not words off limitation. Those skilled in the art will recognize that many modifications and variations are possible without departing from the scope and spirit of the invention as set forth in the appended claims.

1. A fuel injector connector installation tool, comprising:
a first portion having a length with opposing first and second ends; said first end terminating in a handle portion, said second end equipped with a first clamp;
a second portion having a length with opposing first and second ends; said first end terminating in a handle portion and said second end equipped with a second clamp;
said first and second clamp each adapted to matingly receive terminal portions of said first and second portions to removeably mount said clamps thereon;
said first and second portions pivotally connected to each other and resiliently biased away from each other such that forcing said handle portions toward each other causes the first and second clamps to move toward each other to apply compressive force to a connector and a fuel injector to connect them tighter; and releasing the compressive force applied to the handles permits the resiliently biasing of the first and second portions away from each other about the pivot attachment.

2. The fuel injector connector installation tool of claim 1, wherein one of said clamps is adapted to cooperatively engage a fuel injector connector and said other clamp adapted to engage said fuel injector.

3. The fuel injector of claim 1, wherein said first portion is a spring side portion, and said second portion is plug side portion.

4. The fuel injector connector tool of claim 1, further including an adjuster to control the travel of the first and second portions about the pivot.

5. The fuel injector connector installation tool of claim 5, wherein said adjuster is a screw threadably engaged in a threaded aperture in one of said first and second portions, and a set nut on said screw to lock said screw into a desired position; said screw extending a distance toward an opposing portion to limit travel of the portions toward each other about said pivot.

6. The fuel injector connector installation tool of claim 1, wherein said clamps are comprised of a body portion having two opposed flanges at one end separated by a distance to form a space, and a receiving aperture opposite said flanges; said aperture adapted to matingly receive an end of said first or second portions.
